(19) United States
(12) Patent Application Publication
(10) Pub. No.: US 2010/0086828 A1
(43) Pub. Date: Apr. 8, 2010

(54) Carrier device for an electrochemical functional unit, fuel cell module and method for the production of a carrier device

(75) Inventor: Patric Szabo, Oetisheim (DE)

Correspondence Address: Lipsitz & McAllister, LLC, 755 MAIN STREET, MONROE, CT, 06468, US

(73) Assignee: Deutsches Zentrum fuer Luft-und Raumfahrt e.V., Koeln (DE)

(21) Appl. No.: 12/589,885

(22) Filed: Oct. 28, 2009

Related U.S. Application Data
(63) Continuation of application No. PCT/EP2008/055614, filed on May 7, 2008.

(30) Foreign Application Priority Data
May 11, 2007 (DE) 10 2007 024 225.7

(51) Int. Cl. H01M 2/02; B22F 3/11

(52) U.S. Cl. 429/34; 419/2; 29/623.1

(57) ABSTRACT

A carrier device for an electrochemical functional unit is provided, comprising a frame unit consisting of an electrically conductive material and at least one window area which consists of an electrically conductive material and is integrally formed on the frame unit, wherein the at least one window area is produced from a porous material and is permeable to gas via its porosity and wherein the frame unit is impermeable to gas in its solid material.

This application is a continuation of international application number PCT/EP2008/055614 filed on May 7, 2008.

The present disclosure relates to the subject matter disclosed in international application number PCT/EP2008/055614 of May 7, 2008 and German application number 10 2007 024 225.7 of May 11, 2007, which are incorporated herein by reference in their entirety and for all purposes.

### BACKGROUND OF THE INVENTION

The invention relates to a carrier device for an electrochemical functional unit.

In addition, the invention relates to a fuel cell module which comprises an electrochemical functional unit.

In addition, the invention relates to a method for the production of a carrier device for an electrochemical functional unit.

DE 198 41 919 A1 discloses a fuel cell module which has a fuel cell which is provided at its anode and its cathode with a respective current collector. The anode is attached to its current collector with the aid of a solder.

DE 20 2005 020 601 U1 discloses a fuel cell unit, comprising a cathode-electrolyte-anode unit and at least one contact element for the electrically conductive contact with the cathode-electrolyte-anode unit. The at least one contact element comprises a plate which is provided with a plurality of openings.

EP 1 318 560 A2 discloses a support for an electrochemical functional unit of a high-temperature fuel cell which is porous for the supply of reactants and/or discharge of products of reaction.

WO 99/53558 discloses a stack of fuel cells which comprises several fuel cells which are connected electrically and mechanically to one another by way of connecting elements. The connecting elements consist of metal or a metal alloy and each connecting element has at least one electrode compartment and a porous wall. The porous wall of the connecting element separates the electrode compartment from an adjoining anode.

GB 2 368 450 A discloses fuel cells of the type SOFC which comprises a substrate which consists of a ferritic steel and comprises a porous area and a non-porous area, wherein the latter delimits the porous area. A bipolar plate consisting of a ferritic steel is positioned over one surface of the porous area of the substrate and is connected to the non-porous area of the substrate around the porous area via a sealing connection. A first electrode layer is arranged on the other surface of the porous area of the substrate. An electrolyte layer is arranged on the first electrode layer and a second electrode layer is arranged over the electrolyte layer.

GB 2 400 723 A discloses a fuel cell of the type SOFC which comprises a steel substrate with a porous support and a non-porous frame, wherein the frame accommodates the porous support or a number of porous supports.

### SUMMARY OF THE INVENTION

In accordance with an embodiment of the invention, a carrier device is provided which can be produced in a simple manner and has advantageous properties.

In accordance with the invention, the carrier device comprises a frame unit consisting of an electrically conductive material and comprises at least one window area which consists of an electrically conductive material and is integrally formed on the frame unit, wherein the window area is produced from a porous material and is permeable to gas via its porosity and wherein the frame unit is impermeable to gas in its solid material.

The carrier device is electrically conductive via the frame unit and the at least one window area and so it can be used, for example, as a bipolar plate or as an interconnector. Electrical contact to an anode may be provided, for example, via the carrier device. The carrier device can, as a result, serve, for example, as a support for an anode, wherein reaction gas can be passed through to the anode via the at least one porous window area.

As a result of the integral formation of the at least one window area on the frame unit, no solder points or welding points must be provided for the connection. As a result, no jumps occur in the thermal coefficient of expansion since there are no transitions at solder points or welding connections. In addition, jumps in the distribution of stress, in alloy composition etc. are also prevented. As a result, problems in conjunction, for example, with ceramic layers which are arranged on the carrier device are avoided.

The carrier device with the frame unit and the integral, at least one window area may be produced in a simple manner, for example, via powder-metallurgical methods. An integral production is possible. As a result, the number of production steps and, therefore, the production resources are kept low.

As a result of the frame unit which is impermeable to gas—in its solid material—and the at least one window area which is permeable to gas, reaction gas, such as combustible gas or oxidizing agent, may be provided selectively to the electrical functional unit, wherein a high imperviousness of a gas compartment may also be achieved in a simple manner. The frame unit which is impermeable to gas in its solid material can be used as a supply unit for reaction gas in a gas compartment in that corresponding channels are formed in the frame unit. The frame unit can also be used accordingly as a discharge unit for products of reaction.

It is favorable when frame elements of the frame unit surround the at least one window area laterally. As a result, the window area which is permeable to gas may be sealed to the side via the frame unit.

It is particularly advantageous when the at least one window area is arranged in one piece on the frame unit. As a result, no material-locking, form-locking connection or the like between the at least one window area and the frame unit is required.

It is favorable when the at least one window area and the frame unit are produced from the same material. As a result, no jumps in the thermal coefficient of expansion, in the distribution of stress, in the alloy contributions etc. result at the transition between the at least one window area and the frame unit.

It is particularly advantageous when the carrier device is produced powder metallurgically. As a result, a uniform (homogeneous) distribution of material can be achieved. As a result, on the other hand, the oxidation resistance of the carrier device is very high since—for example, in comparison with carrier devices produced by way of embossing—“oxidation weak points” on account of an uneven alloy distribution are avoided. In addition, the carrier device may be produced with a high degree of levelness and so it can be positioned in a housing in a simple manner. As a result, on the other hand, it is possible to use the carrier device in a simple manner for forming fuel cell stacks consisting of a plurality of fuel cells.

It may be provided for the carrier device to comprise one or more supporting feet. The carrier device can be supported via supporting feet on a base, such as, for example, a housing. Electrical contact to the base may, for example, also be achieved via the supporting feet. Furthermore, a gas compartment may be formed, via which reaction gas may be supplied to the electrochemical functional unit through the at least one window area.

In this respect, one or more supporting feet may, in particular, be arranged on the frame unit. As a result, the corresponding mechanical stability may be achieved. For example, a simple connectability to the base (for example, by way of soldering) can also be realized, as a result.

It is favorable, in this respect, when the supporting foot or feet are integrally formed on the frame unit.

It is, in addition, favorable when the supporting feet are arranged and designed such that a gas compartment can be formed beneath the at least one window area. An underside of a supporting foot is then spaced relative to an underside of the at least one window area.

It may be provided for the carrier device to be designed as a bipolar plate or be designed as an interconnector. It can then, at the same time, be a support for an electrochemical functional unit and provide for electrical contact.

In one embodiment, an electrical contact device, via which the frame unit can be supported on a housing, is arranged on the frame unit. The electrical contact device can be an integral part of the frame unit and be formed on it, for example, in one piece. It is also possible for a separate electrical contact device in the form, for example, of a mesh to be fixed to the frame unit, for example, via soldering.

At least one electrochemical functional layer is favorably arranged at the at least one window area. This electrochemical functional layer can be a ceramic layer or a non-ceramic layer, such as, for example, a metallic layer. This electrochemical functional layer can be produced as an integral part during the production of the at least one window area and the frame unit in that, for example, a corresponding starting material is brought into position during a powder-metallurgical process.

In one embodiment, the at least one electrochemical functional layer is an anode layer or cathode layer. Combustible gas may then be supplied to the anode or oxidation gas supplied to the cathode via the porous window area.

It is also possible for the at least one electrochemical functional layer to be a porous anode substrate layer or a porous cathode substrate layer which is electrically conductive and on which an anode layer or cathode layer can, on the other hand, be positioned.

It may be provided for one or more channels to be arranged in the frame unit. A channel is, in this respect, designed, in particular, as a continuous opening in the form of, for example, a bore. As a result, reaction gas may be supplied to, for example, a gas compartment or products of reaction may be discharged through the frame unit.

It may be provided for the carrier device to be designed as a plate, for example, with an essentially flat upper side and essentially a flat underside. In this respect, it is possible for feet to project at the upper side and/or the underside.

The carrier device is favorably designed as a sintered plate. It may, as a result, be produced in a simple and inexpensive manner.

The further object underlying the invention is to provide a fuel cell module of the type specified at the outset which can be produced in a simple manner.

This object is accomplished in accordance with the invention, in the fuel cell module specified at the outset, in that a carrier device according to the invention is used, wherein the electrochemical functional unit is arranged on the carrier device.

The fuel cell module according to the invention has the advantages already discussed in conjunction with the carrier device according to the invention.

The electrochemical functional unit comprises, in particular, a cathode and an electrolyte. The corresponding electrochemical cell reactions can then be carried out.

It may also be provided for the electrochemical functional unit to comprise an electrode. (It is, in principle, possible for the electrode to be part of the carrier device or be part of the electrochemical functional unit).

It is favorable when the anode or the cathode is arranged in the at least one window area. Combustible gas may be supplied to the anode or oxidizing agent may be supplied to the cathode via the window area. The carrier device is, as a result, a mechanical holding device for the anode or the cathode and provides for the suppliability of combustible gas or oxidizing agent.

It is, in addition, favorable when a housing is provided. The carrier device and the functional unit can be accommodated in or at the housing. An anode compartment (or cathode compartment) may, for example, be provided as a result of a housing in order to be able to supply combustible gas to the anode. Furthermore, electrical contact between adjacent fuel cell modules is possible via the housing in order to form a stack of fuel cells.

In this respect, it is, in principle, possible for the carrier device to be a unit separate from the housing or be part of the housing. In the latter case, the fuel cell module can be constructed in a compact manner with a minimal thickness.

In one embodiment, the carrier device forms a cover element of the housing which closes an electrode compartment. The electrode compartment is, for example, an anode compartment, via which combustible gas is supplied to an anode through the at least one window area. The electrode compartment can be closed in a gas-tight manner via the frame unit which is impermeable to gas in its solid material.

It is favorable when a gas-tight electrolyte layer covers the at least one window area completely. As a result, it may be ensured that no combustible gas can pass from the anode side to the cathode side and no oxidation gas can pass from the cathode side to the anode side. The corresponding electrode (for example, the anode) can be covered by the gas-tight electrolyte layer and it is ensured by the complete covering of the at least one window area that the combination consisting of electrode (such as, for example, an anode) and at least one window area is “sealed” so as to be fluid-tight with respect to the other electrode (for example, the cathode).

It is favorable when the housing is produced from a metallic material.

It may be provided for the frame unit to be soldered to the housing or a part of the housing. As a result, an electronic conductor path may be provided. In particular, an electronic conductor path is provided, as a result, which is in addition to the electronic conductor path provided via an electric contact device.

It is favorable when the frame unit is soldered to the housing or a part of the housing on oppositely located sides. It can be soldered, for example, to a lower shell of the housing over a large area. It can, in addition, be soldered to an overlapping area of the housing in order to provide an additional, electronic conductor path.

Further, in accordance with an embodiment of the invention, a method is provided which can be carried out in a simple manner.

In accordance with the invention, a frame unit which is impermeable to gas in its solid material is produced from an electrically conductive material and at least one porous window area which is permeable to gas is produced on the frame unit.

The method according to the invention has the advantages already discussed in conjunction with the carrier device according to the invention and the fuel cell module according to the invention.

Additional, advantageous developments have likewise already been discussed in conjunction with the carrier device according to the invention and the fuel cell module according to the invention.

It is particularly advantageous when the frame unit and the at least one window area are produced from the same material. As a result, mismatch problems at the transition between the at least one window area and the frame unit are avoided. In particular, no jumps in the thermal coefficient of expansion, in the stress behavior, in the alloy composition etc. occur.

It is particularly advantageous when a powder-metallurgical production is provided. As a result, the at least one window area may be produced integrally on the frame unit in a simple manner. The manufacturing steps may be minimized. A green body is produced from starting material compositions and this includes starting areas for the at least one window area and the frame unit. This green body will be sintered and the carrier device is obtained. Where applicable, the body obtained can be subsequently machined, for example, by drilling gas channels in the frame unit.

It is favorable when a metallic powder with a binding agent is used as starting material. As a result, not only the frame unit but also the at least one window area may be produced, wherein it can be set, in particular, by way of variation of the proportion of binding agent whether the corresponding area is permeable to gas or impermeable to gas.

The starting material for the production of the at least one window area is provided, in particular, with a higher proportion of binding agent than the starting material for the production of the frame unit.

It may, in addition, be provided for the starting material for the at least one window area to have a pore-forming agent added to it in order to adjust the porosity accordingly.

It is favorable when a preliminary body, which is produced from the different starting material compositions (green body), is sintered. A sintered body is then obtained which forms the carrier device.

The following description of preferred embodiments serves to explain the invention in greater detail in conjunction with the drawings.

### BRIEF DESCRIPTION OF THE DRAWINGS

FIG. 1 shows a plan view of one embodiment of a carrier device according to the invention;

FIG. 2 shows a schematic sectional view along line 2-2 according to FIG. 1;

FIG. 3 shows a schematic sectional illustration of a first embodiment of a fuel cell module according to the invention;

FIG. 4 shows a schematic sectional illustration of a second embodiment of a fuel cell module according to the invention;

FIG. 5 shows a schematic illustration of method steps for the production of a carrier device according to the invention;

FIG. 6 shows a schematic sectional illustration of a third embodiment of a fuel cell module according to the invention; and

FIG. 7 shows a schematic sectional illustration of a fourth embodiment of a fuel cell module according to the invention.

### DETAILED DESCRIPTION OF THE INVENTION

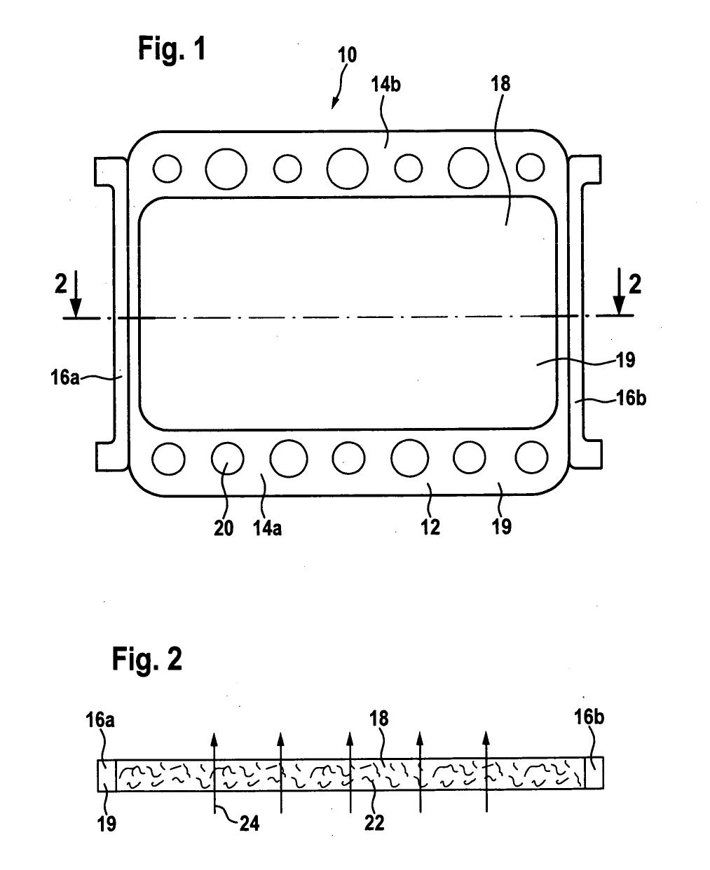

One embodiment of a carrier device according to the invention, which is shown in FIG. 1 and designated as 10, is of a plate-like design. The carrier device 10 comprises a frame unit 12 with frame elements 14a, 14b which are located opposite one another and spaced parallel to one another. Frame elements 16a, 16b are oriented transversely and, in particular, at right angles to these frame elements 14a, 14b. The frame elements 16a, 16b are spaced and, in particular, spaced parallel to one another.

One window area 18 (at least) is held on the frame unit 12. This window area 18 is integrally connected to the frame elements 14a, 14b, 16a and 16b. It is surrounded by the frame unit 12 with its frame elements 14a, 14b, 16a, 16b.

The frame unit 12 is produced from a solid material 19 which is impermeable to gas.

One or more channels 20 for the passage of fluid can be arranged in the frame unit 12 (in the solid material). Channels 20 are, for example, formed in the frame elements 14a and 14b. The channels 20 are designed, in particular, as continuous recesses.

The window area 18 is produced from an open-pored material 22 and so the window area 18 is permeable to gas (which is indicated in FIG. 2 by the arrows with the reference numeral 24). Outside the window area 18, the carrier device 10 is not permeable to gas due to the solid material 19 of the frame unit 12. (A possible permeability to gas materializes solely by way of “macroscopic” channels in the form of perforations or the like).

The carrier device 10 with the frame unit 12 and the window area 18 is produced from a (the same) electrically conductive material. In particular, the frame unit 12 and the window area 18 are produced from a ferritic steel which contains, for example, a proportion of chromium of 17% to 28% and contains a proportion of manganese. The window area 18 also provides an electrical contact path as a result of the porous design (and, therefore, not-complete opening).

The window area 18 is integrally formed on the frame unit 12 so that no additional means of connection, such as a solder connection, weld connection or adhesive connection, is necessary. The frame unit 12 and the window area 18 are, in particular, produced in an integral manner, for example, powder metallurgically.

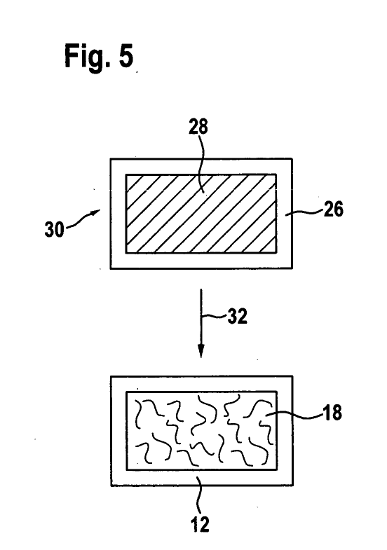

In one embodiment of a production method which is shown schematically in FIG. 5, different starting materials 26, 28 are used; the starting material 26 is used for the production of the frame unit 12 and the starting material 28 for the production of the window area 18. The starting material 26 and the starting material 28 each comprise metallic powder and a binding agent. The proportion of binding agent is higher in the starting material 28 than in the starting material 26. The proportion of binding agent is selected such that following the sintering the frame unit with its solid material is impermeable to gas and the window area is porous and permeable to gas.

A preliminary body 30 is produced from the starting material 26 and the starting material 28. For this purpose, the starting material 26 and the starting material 28 are positioned in accordance with the shape of the frame unit 12 and the (at least one) window area 18 to be produced.

In one embodiment, pressing takes place and a subsequent hardening for the purpose of forming a green body.

It is also possible to position the starting material 26 and the starting material 28 accordingly via a PIM (powder injection molding) method by way of die casting.

It is, for example, also possible to produce the preliminary body 30 in a film casting method via corresponding positioning of pastes on the starting material 26 and the starting material 28.

The preliminary body 30 (green body) is sintered. This is illustrated schematically in FIG. 5 by the arrow with the reference numeral 32. Pores are formed in the starting material 28 by way of heat treatment and the window area 18 is produced. This is surrounded by the frame unit 12, wherein the window area 18 is integrally formed on the frame unit 12.

The carrier device 10 is then obtained. This is designed as a sintered plate. As it is produced from an electrically conductive material, it may also be used as a bipolar plate in order to be in contact, for example, directly or indirectly with a cathode on one side and directly or indirectly with an anode on another side.

The special design of the frame unit 12 and of the window area or areas 18 is adapted to the specific application. Several window areas may, for example, be provided which are surrounded by the corresponding frame elements of the frame unit.

One or more additional layers may also be produced on the carrier device 10 integrally with its production. For example, one or more ceramic layers may be arranged on the window area 18 and/or the frame unit 12 directly and integrally during the production of the carrier device 10. For this purpose, one or more additional layers of an additional starting material are positioned on corresponding areas for the production of the preliminary body 30.

The carrier device 10 may be used, for example, as a bipolar plate or an interconnector for a high-temperature fuel cell and, in particular, an oxide-ceramic fuel cell (an SOFC fuel cell).

The carrier device 10 can serve as a substrate for an electrochemical functional unit. For example, an electrically conductive carrier substrate for an anode is arranged directly on the carrier device 10 or the anode is arranged directly at the window area 18 of the carrier device 10.

It is, in principle, also possible for the carrier device to be a carrier substrate for a cathode.

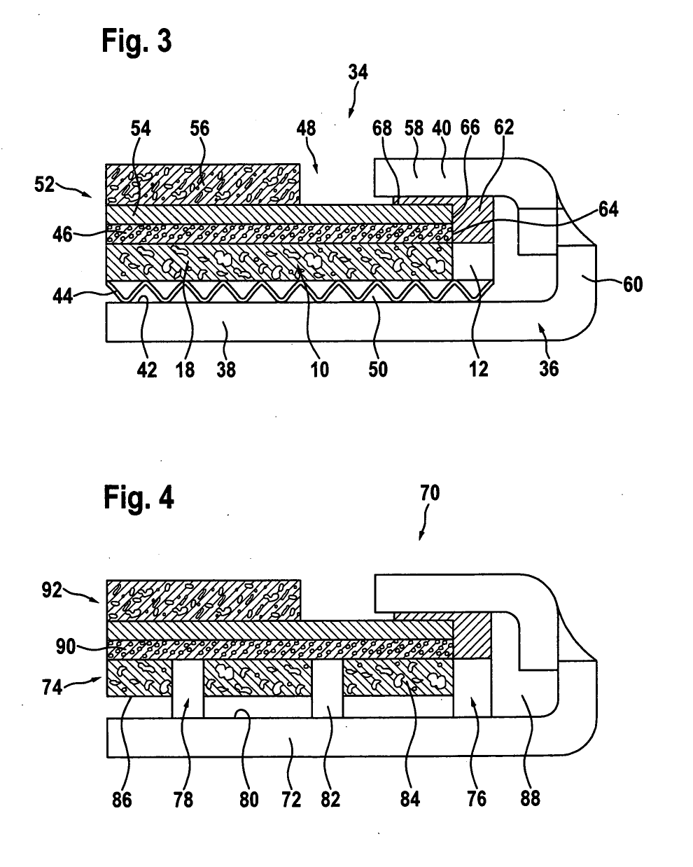

A first embodiment of a fuel cell module, which is shown in FIG. 3 and designated as 34, has a carrier device 10 with the frame unit 12 and the window area 18.

The fuel cell module 34 comprises a housing 36 consisting of a metallic material with a first housing section 38 and a second housing section 40. The first housing section 38 has an essentially flat inner side 42. An electrical contact device 44 is arranged on this inner side 42. The carrier device 10 is supported on the electrical contact device 44 and is connected to it, for example, by way of soldering. The electrical contact device 44 is, itself, connected to the first housing section 38, for example, by way of soldering. The electrical contact device 44 is designed such that it provides an electrical contact between the housing 36 and an anode 46 of an electrochemical functional unit 48 which is arranged on the carrier device 10. It is designed to be permeable to gas so that reaction gases can pass through the electrical contact device 44 and through the window area 18 of the carrier device 10 to the anode 46 so that electrochemical cell reactions can be carried out at the anode. The electrochemical contact device 44 is designed, for example, as a mesh or a woven or knitted fabric.

An anode compartment 50, into which reaction gases (combustible gases) can be coupled, for example, via channels 20 and via which the anode 46 can be supplied with reaction gases, is formed between the carrier device 10 and the inner side 42 of the housing 36.

The electrochemical functional unit 48 is formed via an anode-electrolyte-cathode unit 52. It comprises the anode 46 which is produced, for example, from an oxide-ceramic material, such as zirconium oxide stabilized by yttrium and nickel as catalyst.

An electrolyte layer with an electrolyte 54 impermeable to gas is arranged on the anode 46. This electrolyte 54 is not conductive for electrons. It is, however, conductive for oxygen ions. It is produced, in particular, from a ceramic material, such as, for example, from zirconium oxide stabilized by yttrium.

A cathode 56 is arranged on the electrolyte 54. The cathode is produced from an oxide-ceramic material. For example, mixed oxide systems, such as lanthanum-strontium-manganate, are used for its production.

In the case of a high-temperature fuel cell, the following cell reactions take place at the cathode 56:

$$\frac{1}{2} {O}_{2} + 2 {e}^{-} \to {O}^{2 -}$$

Fuel is supplied to the anode 46. The following cell reactions take place:

H₂+O²⁻→H₂O+2e⁻

The corresponding fuel cell is operated at a temperature in the range of approximately 650° C. to 1000° C.

The fuel (which is or contains hydrogen gas) may be delivered, for example, via a reformer.

The second housing section 40 is arranged to as to overlap partially with the carrier device 10. It has an overlapping area 58 which is spaced laterally in relation to the cathode 56 and is located above the inner side 42. This overlapping area 58 projects away from a side wall 60. The overlapping area 58 is preferably arranged at least approximately parallel to the inner side 42 and transversely and, for example, at right angles to the side wall 60. The second housing section 40 and the first housing section 38 have, in this respect, the same electrical potential. They are connected to one another accordingly; for example, they are connected to one another in one piece.

In one embodiment, the carrier device 10 is connected to the overlapping area 58 of the second housing section 40 via a solder layer 62 so as to be electrically conductive. The solder layer 62 is arranged on the frame unit 12. It abuts, in addition, on end sides 64, 66 of the anode 46 and the electrolyte 54. Furthermore, it abuts on an upper side 68 of the electrolyte 54. This solder layer 62 is designed to extend all around. Apart from the electrical contact between the housing 36 and the anode 46 (via its end side 64) and the electrical contact to the carrier device 10 in addition to the electrical contact device 44, the solder layer provides for a fluid seal which seals the anode compartment 50 in relation to the cathode 56. Furthermore, it provides for a mechanical fixing in position of the carrier device 10 and the electrochemical functional unit in the housing 36.

Electrical contact to the anode 46 is provided via the solder layer 62 (directly via the end side 64 and indirectly via the solder layer 62 on the frame unit 12 via the carrier device 10) in addition to the electrical contact device 44.

As a result of this additional contact, a further, electronic conductor path is provided in addition to the electronic conductor path via the electrical contact device 44.

The window area 18 is not reduced in size as a result of the positioning of the solder layer 62 on the frame unit 12.

Several fuel cell modules 34 may be combined with one another to form a stack of fuel cells. For example, the cathode 56 is in contact with the housing 36 of an adjacent fuel cell.

It is, in principle, possible for the fuel cell module to have a reverse construction with respect to the arrangement of anode, electrolyte and cathode. The cathode can be arranged on a cathode support as first layer. The electrolyte layer is arranged on the cathode and the anode is arranged on the electrolyte as final layer.

In a second embodiment of a fuel cell module, which is shown schematically in FIG. 4 and designated as 70, a carrier device 74 is arranged in a housing 72 which is, for example, of the same design as the housing 36. This carrier device has a frame unit 76, on which an electrical contact device 78 is integrally formed. The carrier device 74 is mechanically supported on an inner side 80 of the housing 72 via this electrical contact device 78, wherein an electrical contact is, at the same time, provided, for example, by a solder connection.

The electrical contact device 78 is formed, for example, by supporting feet 82 which are arranged on the frame unit 76 and are formed, in particular, in one piece.

The frame unit 76 holds one or more window areas 84 which have an underside 86 which is spaced in relation to the inner side 80 of the housing 72. This spacing is brought about by the supporting feet 82. An anode compartment 88 is formed in the housing 72 as a result of the space between the underside 86 of the window areas 84 and the inner side 80. Combustible gases can be supplied to the window areas 84 via the anode compartment and pass through the porous material of these window areas 84 to an anode 90 of an anode-electrolyte-cathode unit 92.

In the embodiment described, the electrical contact device 78 is integrated into the carrier device 74.

Otherwise, the fuel cell module 70 operates as described above on the basis of the fuel cell module 34.

As a result of the solution according to the invention, a carrier device for an electrochemical functional unit is provided which is electrically conductive (for conducting electrons). The carrier device may be designed, as a result, as a bipolar plate or an interconnector. It can support electrochemical functional layers. For example, an anode substrate is arranged directly on the carrier device 10 or an anode layer.

The window area or areas 18 are then integrated directly into the frame unit 12. For this purpose, no subsequent soldering or welding is required. Soldering or welding can lead to stressing which can lead to distortion. Uneven parts are not suitable for the construction of a stack of fuel cells. As a result of the solution according to the invention of an integral carrier device 10, problems with transitions at solder points or weld connections are avoided; no jumps in the coefficient of expansion, the distribution of stress, alloy contributions etc. result. Consequently, there are also no problems with ceramic layers which are arranged on the carrier device 10 since these ceramic layers are not arranged at solder points or weld points.

The carrier device 10 has no jumps in the thermal coefficient of expansion, in the distribution of stress, in the alloy contributions etc. It may be produced in a simple manner with a minimum number of production steps. The production step necessary for the production of a window area 18 is utilized at the same time for the production of the frame unit 12.

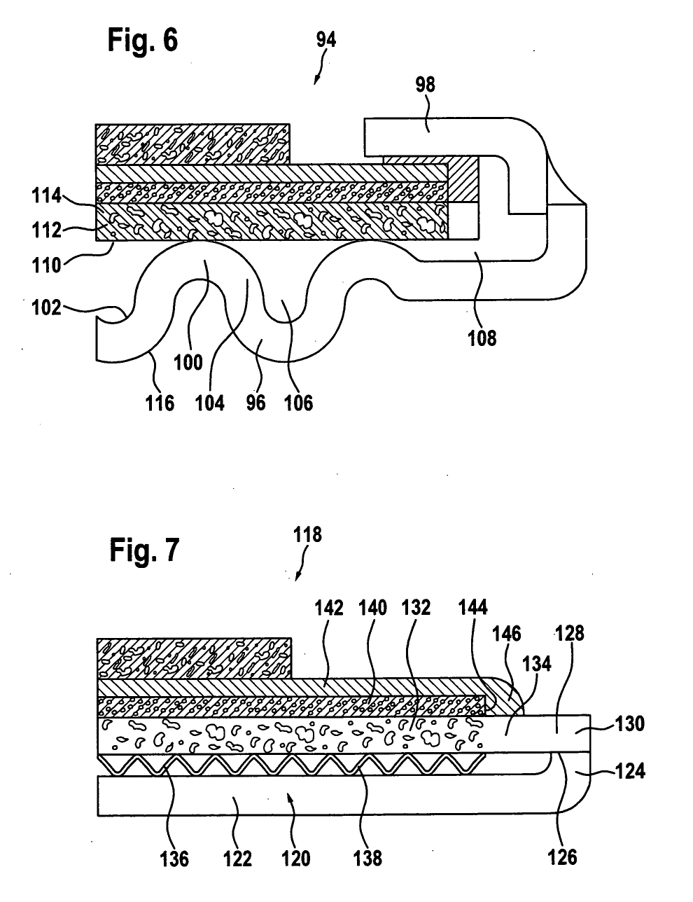

A third embodiment of a fuel cell module according to the invention, which is shown in FIG. 6 and designated as 94, comprises a housing 95 with a first housing section 96 and a second housing section 98. The second housing section 98 is, in principle, of the same design as the second housing section 40 of the fuel cell module 34.

The first housing section 96 has a base area 100 which is of a “wavy” design. An inner side 102 of this base area 100 comprises spaced elevations 104, between which channels 106 are formed. The channels 106 are connected to one another in such a manner that an anode compartment 108 is formed. The anode compartment 108 is closed upwardly by the second housing section 98.

The elevations 104 have an enveloping end 110 which is essentially a plane.

An anode carrier 112 is arranged on the elevations 104. It is connected to the elevations 104, for example, by welding or soldering.

An electrochemical functional unit with an anode, an electrolyte layer and a cathode is seated on the anode carrier. The construction of the anode carrier, which is formed by a carrier device according to the invention, and of the electrochemical functional unit as well as the connection to the second housing section 98 are, in principle, the same as described for the embodiment 34.

In the case of the fuel cell module 94, the carrier device 114 (which corresponds to the anode carrier 112) is supported directly on the first housing section 96. An electrical contact device in accordance with the electrical contact device 44 is not provided.

The first housing section 96 is designed as a gas distributor. The gas distributor which is formed by the elevations 104 on the inner side 102 of the first housing section 96 is a gas distributor for combustible gas.

A gas distributor is likewise formed on an outer side 116 located opposite the inner side 102. A cathode of an adjacent fuel cell module may be connected to the outer side 116, wherein the cathode can be supplied with oxidation gas through the corresponding channels in the outer side 116.

Otherwise, the mode of operation of the fuel cell module 94 corresponds to the mode of operation of the fuel cell module 34.

In a fourth embodiment of a fuel cell module according to the invention, which is shown in FIG. 7 and designated as 118, a housing 120 with a first housing section 122 is provided. The first housing section 122 is designed as a lower shell. The first housing section 122 comprises a raised edge area 124 extending all around and having an essentially flat end face 126. A carrier device 128 is seated in place on the end face and is connected to the edge area 124 of the first housing section 122, for example, by soldering or welding. The carrier device 128 is placed on the edge area 124 with a frame area 130 which is impermeable to gas.

A porous window area 132 which is permeable to gas is integrally formed on the frame area 130.

The carrier device 128 forms a second housing section 134 with its frame area 130, in particular. An anode compartment 136 is limited by the carrier device 128 as second housing section 134 and the first housing section 122 with its raised edge area 124. An electrical contact device 138 is arranged in this anode compartment and operates, in principle, like the electrical contact device 44 described above. The electrical contact device 138 is connected, in particular, to the first housing section 122 and is connected to the carrier device 128.

It is, in principle, possible for the first housing section 122 to be connected directly to the carrier device 128.

An anode 140 is arranged on the carrier device 128. This is seated, in particular, on the window area 132 without projecting beyond it.

The anode 140 is covered by an electrolyte layer 142. The electrolyte layer 142 extends over a side surface 144 of the anode 140 into the frame area 130, i.e., the electrolyte layer 142 has an area 146 which is located on the frame area 130 of the carrier device 128.

The electrolyte layer 142 is gas-tight. It covers the anode 140 outwardly and upwardly and outwardly to the side via the area 146. Since the area 146 is placed on the frame area 130, no combustible gas can pass sideways from the window area 132 directly onto the cathode side or pass through the anode 140 onto the cathode side.

It is, in principle, also possible for the electrolyte layer 142 to cover the frame area 130 upwardly completely. As a result, the insulation effect with respect to electronic conduction of the fuel cell module 118 to an adjacent fuel cell module is increased.

The surface area which is covered by the electrolyte layer 142 is greater than the surface area of the window area 132 and is also greater than the surface area of the anode 140.

Otherwise, the fuel cell module 118 operates as described above.

1. Carrier device for an electrochemical functional unit, comprising:
a frame unit consisting of an electrically conductive material; and
at least one window area consisting of an electrically conductive material and being integrally formed on the frame unit;
wherein the at least one window area is produced from a porous material and is permeable to gas via its porosity; and
wherein the frame unit is impermeable to gas in its solid material.

2. Carrier device as defined in claim 1, wherein frame elements of the frame unit surround the at least one window area laterally.

3. Carrier device as defined in claim 1, wherein the at least one window area is arranged in one piece on the frame unit.

4. Carrier device as defined in claim 1, wherein the at least one window area and the frame unit are produced from the same material.

5. Carrier device as defined in claim 1, wherein it is produced powder-metallurgically.

6. Carrier device as defined in claim 1, wherein it comprises one or more supporting feet.

7. Carrier device as defined in claim 6, wherein one or more supporting feet are arranged on the frame unit.

8. Carrier device as defined in claim 6, wherein the supporting feet are arranged and designed such that a gas compartment is adapted to be formed beneath the at least one window area.

9. Carrier device as defined in claim 1, wherein it is designed as a bipolar plate.

10. Carrier device as defined in claim 1, wherein it is designed as an interconnector.

11. Carrier device as defined in claim 1, wherein an electrical contact device is arranged on the frame unit, the frame unit being supportable on a housing via said contact device.

12. Carrier device as defined in claim 1, wherein at least one electrochemical functional layer is arranged at the at least one window area.

13. Carrier device as defined in claim 12, wherein the at least one electrochemical functional layer is produced integrally with the window area.

14. Carrier device as defined in claim 12, wherein the at least one electrochemical functional layer is an anode layer or a cathode layer.

15. Carrier device as defined in claim 12, wherein the at least one electrochemical functional layer is a porous anode substrate layer or a porous cathode substrate layer.

16. Carrier device as defined in claim 1, wherein one or more channels are arranged in the frame unit.

17. Carrier device as defined in claim 16, wherein one channel is designed as a continuous opening.

18. Carrier device as defined in claim 1, wherein it is designed as a plate.

19. Carrier device as defined in claim 1, wherein it is designed as a sintered plate.

20. Carrier device as defined in claim 1, wherein the frame unit and the at least one window area are produced from steel.

21. Fuel cell module, comprising:
an electrochemical functional unit; and
a carrier device;
wherein the electrochemical functional unit is arranged on the carrier device;
said carrier device comprising:
a frame unit consisting of an electrically conductive material; and
at least one window area consisting of an electrically conductive material and being integrally formed on the frame unit;
wherein the at least one window area is produced from a porous material and is permeable to gas via its porosity; and
wherein the frame unit is impermeable to gas in its solid material.

22. Fuel cell module as defined in claim 21, wherein the electrochemical functional unit comprises a cathode and an electrolyte.

23. Fuel cell module as defined in claim 21, wherein the electrochemical functional unit comprises an anode.

24. Fuel cell module as defined in claim 23, wherein the anode or the cathode is arranged at the at least one window area.

25. Fuel cell module as defined in claim 21, wherein a housing is provided.

26. Fuel cell module as defined in claim 25, wherein the carrier device is arranged on the housing.

27. Fuel cell module as defined in claim 25, wherein the carrier device is part of the housing.

28. Fuel cell module as defined in claim 27, wherein the carrier device forms a cover element of the housing closing an electrode compartment.

29. Fuel cell module as defined in claim 27, wherein a gas-tight electrolyte layer covers the at least one window area completely.

30. Fuel cell module as defined in claim 25, wherein the housing is produced from a metallic material.

31. Fuel cell module as defined in claim 25, wherein the frame unit is soldered to the housing or a section of the housing.

32. Fuel cell module as defined in claim 31, wherein the frame unit is soldered to the housing on oppositely located sides.

33. Method for the production of a carrier device for an electrochemical functional unit, comprising:
producing a frame unit impermeable to gas in its solid material from an electrically conductive material; and
producing at least one porous window area permeable to gas on the frame unit.

34. Method as defined in claim 33, wherein the frame unit and the at least one window area are produced from the same material.

35. Method as defined in claim 33, wherein the carrier device is produced powder-metallurgically.

36. Method as defined in claim 33, wherein a metallic powder with a binding agent is used as starting material.

37. Method as defined in claim 36, wherein the starting material for the production of the at least one window area has a higher proportion of binding agent than the starting material for the production of the frame unit.

38. Method as defined in claim 36, wherein the starting material for the at least one window area comprises a pore-forming agent.

39. Method as defined in claim 33, wherein a preliminary body is sintered.
